(19) United States
(12) Patent Application Publication
(10) Pub. No.: US 2019/0331009 A1
(43) Pub. Date: Oct. 31, 2019

(54) INTERNALLY COOLED VALVE GUIDE

(71) Applicant: Ford Global Technologies, LLC, Dearborn, MI (US)

(72) Inventors: Ellen Cheng-chi LEE, Ann Arbor, MI (US); Joy Hines FORSMARK, St. Clair Shores, MI (US); Mark Michael MADIN, Canton, MI (US); Christopher Donald WICKS, Allen Park, MI (US); John CORNELL, Allenton, MI (US)

(73) Assignee: Ford Global Technologies, LLC, Dearborn, MI (US)

(21) Appl. No.: 15/962,236

(22) Filed: Apr. 25, 2018

(51) Int. Cl. F01L 3/08; F01L 3/18

(52) U.S. Cl. CPC F01L 3/08; B33Y 80/00; F01L 3/18

(57) ABSTRACT

An engine component includes stratified layers that form an integral cylinder head and an internally cooled valve guide located in a cylinder head guide boss. The integral cylinder head further includes a coolant passage within a body of the valve guide that is in fluid communication with a cylinder head cooling jacket.

### TECHNICAL FIELD

The disclosure is directed to an integral engine cylinder head and a cooled valve guide assembly, and a method of manufacturing the same.

### BACKGROUND

To positively locate poppet valves in a cylinder head of a reciprocating internal combustion engine, a valve guide is provided for each valve. In time, the valve guide may suffer wear and damage due to exposure to high temperatures, especially on the exhaust side. The wear may in turn result in a lower ability of the guide to positively locate the valve to the valve seat and the valve's ability to seal the combustion chamber properly. Consequently, engine performance may decrease, oil consumption may increase, and the amount of produced emissions may escalate.

### SUMMARY

An engine component includes stratified layers forming an integral cylinder head, guide boss, and valve guide in the guide boss. The valve guide has walls defining an axial passageway configured to receive and guide a valve. The valve guide also defines a coolant passage internal to the walls, wrapping around the axial passageway, and in fluid communication with a cylinder head cooling jacket via the guide boss. The guide boss may define a seal around the valve guide to an oil drain. The guide boss may define a seal around the valve guide to a combustion chamber. The guide boss may define a coolant inlet annulus and a coolant outlet annulus in fluid communication with the coolant passage and cylinder head cooling jacket. The coolant passage may be helical. The coolant passage may have a lattice structure. The coolant passage may include an inlet and an outlet in fluid communication with the cylinder head cooling jacket. The inlet may be connected with a lower portion of the cooling jacket.

A powertrain assembly includes layered material that defines an integral cylinder head including a valve guide having walls defining an axial passageway configured to receive and guide a valve, and defining an internal coolant channel having an inlet and outlet. The integral cylinder head also includes a cooling jacket, a first duct between the cooling jacket and inlet, and a second duct between the cooling jacket and outlet. The channel may wrap around the axial passageway. The channel may be helical. The channel may include a lattice structure. The inlet may further include a coolant inlet annulus and the outlet may further include a coolant outlet annulus. The cylinder head may further include an external seal to an oil drain arranged in a top portion of the valve guide. The cylinder head may further include an external seal to a combustion chamber arranged in a bottom portion of the valve guide.

An integral cylinder head includes a guide boss and a fluid-cooled valve guide arranged in the guide boss. The valve guide has a cylindrical body defining an axial passageway configured to receive and guide a valve, a coolant passage internal to the cylindrical body, and an inlet and outlet in fluid communication with the coolant passage and a cooling jacket. The integral cylinder head, valve guide, and cooling jacket may be formed from stratified layers such that there are no interfaces requiring separate seals between the cylinder head, valve guide, and cooling jacket. The integral cylinder head, valve guide, and cooling jacket may be formed from the same material. The integral cylinder head may define a duct leading from the valve guide to the cooling jacket. The duct may be bifurcated.

### BRIEF DESCRIPTION OF THE DRAWINGS

FIG. 1 depicts a cross-sectional view of a portion of a prior art cylinder head with conventional valve guides;

FIG. 2 depicts a cross-sectional view of a portion of a cylinder head according to one or more embodiments disclosed herein, the cylinder head having an example internally cooled valve guide connected to a coolant supply;

FIG. 3 depicts a view of the internally cooled valve guide depicted in FIG. 2 with a coolant passage within the guide body;

FIG. 4 shows a cross-sectional view of the internally cooled valve guide depicted in FIG. 3 along the line 4-4;

FIG. 5 shows a cross-sectional view of the valve guide with the ducts for supplying a coolant from a coolant supply and their placement within the cylinder head; and

FIGS. 6A and 6B show alternative configurations of the ducts for supplying a coolant to the valve guide.

### DETAILED DESCRIPTION

Reference will now be made in detail to compositions, embodiments, and methods of the present invention known to the inventors. But it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

A valve guide is a component of a reciprocating engine. A valve guide is provided for each poppet valve in a cylinder head. A conventional valve guide 10 and its cross-section and placement in a cylinder head 12 is depicted in FIG. 1. Together with a valve spring (not depicted), the valve guide 10 serves to positively locate the valve (not depicted) so that the valve makes proper contact with the valve seat insert while providing necessary perpendicularity back to the spring seat 14 to properly supply the correct spring tension or installed height. Typically, a valve guide is a cylindrical metal piece, which is pressed or cast into the cylinder head. The valve reciprocates within the valve guide. A valve guide also conducts heat from the combustion process from the exhaust valve into the cylinder head, where the heat may be absorbed by the cooling system.

Yet, typically, in time, a valve guide may succumb to premature wear that may lead to poor valve stem-to-guide sealing and subsequent oil migration into the cylinder head. For example, the inner diameter of the valve guide and the outer diameter of the valve stem may become worn. As the valve guide wears, its ability to positively locate the valve to the valve seat diminishes. The valve guide thus loses its ability to seal the combustion chamber properly, which may result in loss of engine performance and increase in oil consumption as oil may leak from the oil drain portion of the cylinder head located above the combustion chamber and below the cam cover. This oil would contaminate the fuel/air charge within a running engine in which the oil would be burned during the combustion process. If enough oil is present where the combustion process cannot consume it all, the remainder of the unburned oil may pass into the exhaust system, and possibly further, to contaminate the light off catalyst causing an emission issue.

The wear may occur partially due to high temperatures the valve guide is exposed to. Excessive wear may occur in boosted engine applications, especially on the exhaust side. Thus, it would be desirable to provide a valve guide with increased lifetime.

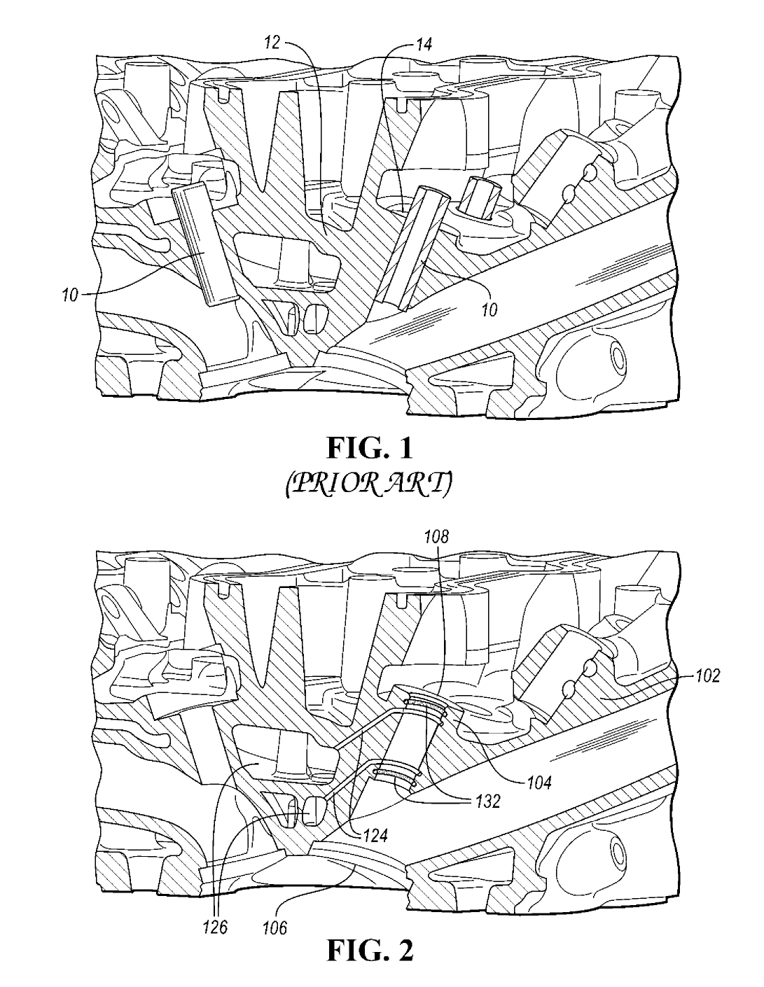

In one or more embodiments, a valve guide 100 is disclosed. The valve guide 100, as depicted in FIG. 2, forms an integral portion of a cylinder head 102. The valve guide is located in a cylinder head valve guide boss 104 between the combustion chamber 106 and the valve spring seat 108.

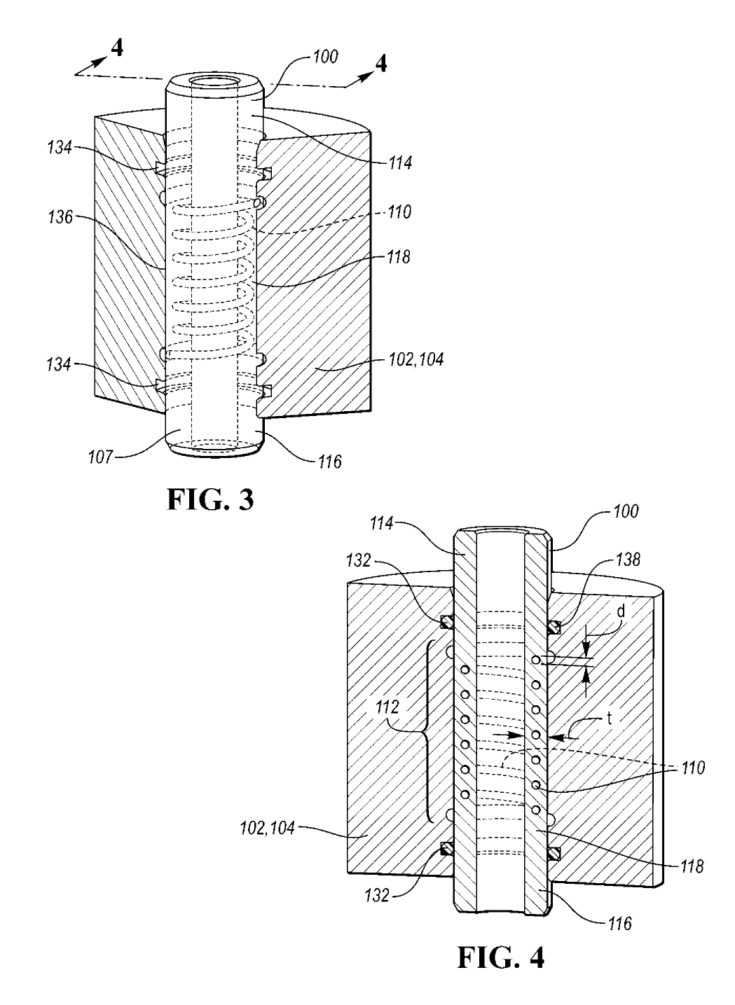

Unlike the prior art valve guides, the valve guide 100 is cooled. The cooling is implemented by providing an internal passage, passageway, channel, chamber, tunnel, artery, canal, conduit, or duct 110 within the valve guide 100, as can be seen in FIGS. 3 and 4. The passage 110 is arranged within the body 107 of the valve guide 100 such that a coolant may flow via a coolant portion 112 of the valve guide 100 and lower the temperature of the valve guide 100 as the coolant advances through the coolant portion 112 of the valve guide 100. The cooling is thus provided within the valve guide 100.

The passage 100 may have a uniform or non-uniform diameter. The diameter d of the passage 100 is smaller than a thickness t of the valve guide body 107 such that the passage 110 is internal to the valve guide 100. This also ensures that the coolant does not come in contact with the valve stem or the valve guide boss 104. The passage diameter d may be about 1/32, 1/16, ⅛, ¼, ½, ⅓ of the valve guide body thickness t.

The coolant portion 112 may form only a section of the valve guide 100. Alternatively, the coolant portion 112 may form a majority of the valve guide length. Alternatively still, using a non-helical strategy the coolant portion 112 may include the entire length of the valve guide 100. The coolant portion 112 may represent about 5, 10, 20, 30, 35, 40, 45, 50, 55, 60, 65, 70, 75, 80, 85, 90, 95%, or more of the valve guide length. The coolant portion 112 may be about 1/32, 1/16, ⅛, ¼, ½, ⅓ of the valve guide length. The coolant portion 112 may extend from the top portion of the valve guide 114 to the bottom portion of the valve guide 116. Alternatively, the coolant portion 112 may be present only in the middle portion of the valve guide 118. The middle portion of the valve guide 118 may be defined by the passage portion 112.

The passage 110 may be shaped like a hollow tube. The passage 110 may be helical. The number of winds of the helix may be 1, 2, 3, 4 5, 6, 7, 8, 9, 10, or more. The passage 110 may have a different shape than a spiral. The passage 110 may have a different shape and configuration. For example, the passage 110 may include a lattice structure. The passage 110 may have a generally circular, oval, rectangular, square, regular, or irregular cross-section. The passage 110 may have a uniform or non-uniform diameter. The passage 110 may have uniform or non-uniform dimensions throughout its length. In one or more embodiments, the valve guide 100 may include more than one passage 110. For example, the valve guide 100 may include two passages 110, both carrying the same or different coolant to and from the same or different locations. The passages 110 may or may not intersect. The passages 110 may or may not be discreet.

The passage 110 includes an inlet 120 and an outlet 122. Both the inlet 120 and the outlet 122 include an orifice. The orifice may have a circular, oval, square, rectangular, regular, or irregular cross-section. Both the inlet 120 and outlet 122 may have the same or different cross-section.

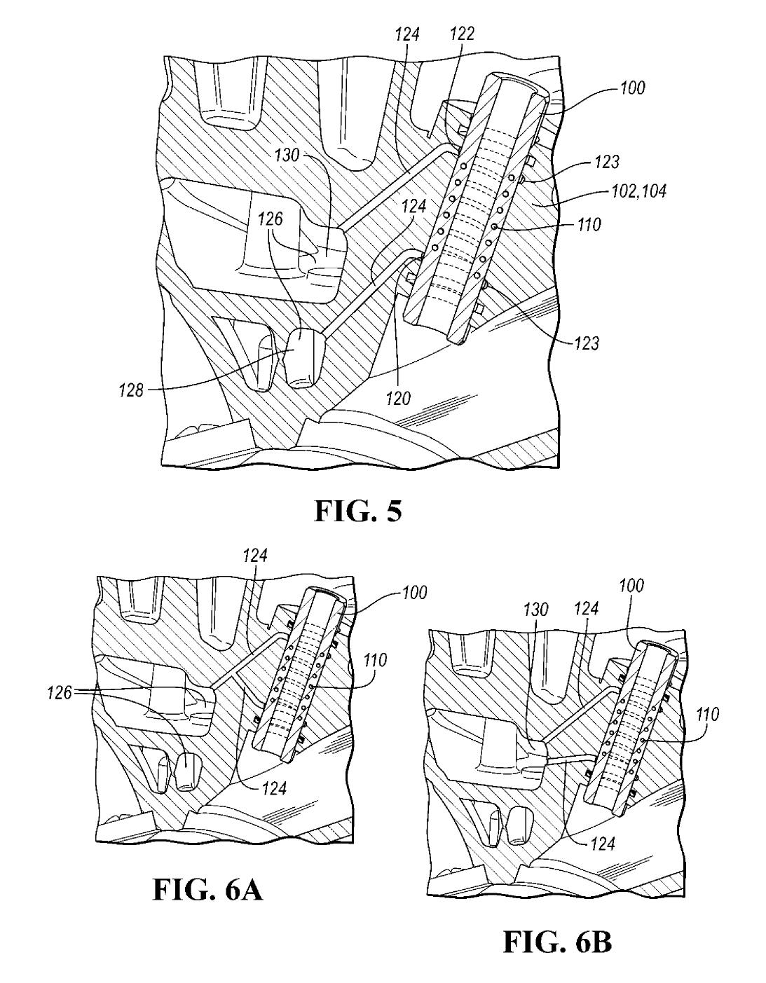

The inlet 120 may be connected at the bottom-most section of the passage 110. The outlet 122 may form the top-most section of the passage 110, as is depicted in an example embodiment of FIG. 5. Alternatively, the outlet 122 may be connected at the bottom-most section of the passage 110 and the inlet 120 may form the top-most section of the passage 110. Alternatively still, the inlet 120 and the outlet 122 may form the same orifice located in a middle portion 118 of the valve guide 100. In such an embodiment, the passage 110 may proceed in one direction for a certain length to cool a portion of the valve guide 100 and then proceed in an opposite direction to cool another portion of the valve guide 100. For example, the passage 110 may advance towards the bottom portion 116 of the valve guide 100, then turn towards the top portion 114 of the valve guide 100 only to turn towards the orifice representing both inlet 120 and outlet 122.

The inlet 120, the outlet 122, or both may include an annulus 123. The annulus 123 is a ring-shaped object or region. The annulus 123 may wrap around a portion of the valve guide body 107. The annulus 123 may connect a duct 124 with the inlet 120, the outlet 122, or both. The annulus 123 removes any misalignment that may occur from component manufacturing variability or tolerances such that there is no requirement to index or control the angular position of the valve guide 100 upon installation. The annulus 123 thus helps to ensure that there is fluid communication between the coolant inlet 120, outlet 122, and the passage 110. The annulus 123 may be located in a groove 134. The groove 134 may be formed on the outer surface 136 of the valve guide 100, in the guide boss 104, or both.

The coolant is supplied to the passage 100 via one or more ducts, feeds, conduits, canals, or passageways 124. The duct 124 may lead from a source or supply of the coolant such as a water jacket or cooling jacket 126. The valve guide 100 and the passage 110 are thus in fluid communication with the cooling jacket 126. The coolant may be supplied from a lower portion 128 of the cooling jacket 126, the top portion 130 of the cooling jacket 126, or both. In an example embodiment depicted in FIG. 5, the coolant is being supplied from the lower section 128 of the cooling jacket 126 via a first duct 124 to the inlet 120, the coolant travels via the passageway 110 towards the top portion of the guide boss 104, and exits the passageways 110 via the outlet 122 into a second duct 124 which leads to a top section 130 of the cooling jacket 126.

The valve guide system 100 has an entry and an exit to provide constant fluid movement. Otherwise, there may be a risk of creating steam pockets within the guide cooling passageways 110, which may decrease efficiency of the valve guide 100. Thus, feeding the coolant from the lower section 128 of the cooling jacket 126 and returning the coolant to the top section 130 of the jacket 130 may be optimal as there is always a pressure differential between the upper and lower jackets 128, 130. The pressure drop makes the coolant flow or move.

Yet, in another embodiment, the coolant may be supplied from the top section 130, flow through the passage 110 towards the combustion chamber 106, and exit to the lower section 128 of the cooling jacket 126. The alternate configuration may not be as desirable as the above-described option depicted in FIG. 5 from a functionality prospective as it may not be optimal for removal of trapped air and steam pockets from the system, and may have slower coolant flow.

Additional arrangements of the one or more ducts 124 are also contemplated. For example, as is depicted in FIG. 6A, a single duct 124 may be provided which may supply the coolant to the passage 110. The duct 124 may be bifurcated such that a portion of the duct leads to the inlet 120 and another portion of the same duct 124 leads to the outlet 122. In an alternative embodiment, a single duct 124 may be provided for the single inlet-outlet arrangement described above.

Alternatively still, as is shown in a non-limiting example of FIG. 6B, two ducts 124 may be provided, both connected to the same coolant supply such as the top section 130 of the cooling jacket 126. Yet, as was mentioned above, the valve guide system 100 must have an entry and an exit to provide constant fluid movement to prevent formation of steam pockets. A coolant supply originating from the same volume may achieve little or diminished coolant flow.

The valve guide 100 may further include one or more seals 132. The seal 132 may be a mechanical seal which fills a space between mating surfaces of the valve guide 100 and the cylinder head 102, the guide boss 104, or both. The seal 132 may be a gasket. The seal 132 may compensate for surface irregularities. The seal 132 may be an external seal. For example, as is depicted in FIGS. 3 and 4, the seal 132 may be located in the top portion 114 of the valve guide 100, the bottom portion 116 or the valve guide 100, or both. The seal 132 may be located between the passage 110 and the top portion of the guide boss 104. The seal 132 may be located between the passage 110 and the combustion chamber 106. The seal 132 may be an external seal to an oil drain. The seal 132 may be an external seal to a combustion chamber 106. The seal 132 may be provided in a groove 134 formed on the outer surface 136 of the valve guide 100, in the guide boss 104, or both. In at least some embodiments, the seal 132 is not included.

The seal 132 may include a sealing material 138 which may be the same or different material than the material the valve guide 100 is made from. For example, the sealing material 138 may be a material resistant to fluids such as engine oil, high temperatures, fluctuating temperatures, fluctuating pressure, or the like. The material 138 may be metal, rubber, nitrile rubber, silicone, neoprene, polytetrafluoroethylene, polychlorotrifluoroethylene, or a different plastic or composite material.

The coolant may be any coolant capable of lowering temperature of the valve guide 100 while flowing to/from a coolant supply via the passage 110. For example, the coolant may be an engine coolant such as water, glycol water mixture, engine oil, or the like. The coolant is a fluid. The coolant may be a coolant which is already present in the engine system such as the cylinder head, which already circulates in the cylinder head, and/or which is provided for cooling of the engine and its parts. The valve guide passage 110 may thus utilize a coolant which is already present in the engine system for its cooling needs such that no additional coolant has to be provided for the valve guide 100.

The coolant may be supplied from the coolant supply in a passive, non-controlled manner. The passive system without any sensors and controllers may utilize pressure, gravity, or the like to transport the coolant via the valve guide 100.

A method of forming the cylinder head 102 with the integral valve guide 100 is also disclosed herein. The enabler for production of the disclosed integral cylinder head 102 and valve guide 100, having unique structural features depicted in the Figures and described above, may be additive manufacturing. Additive manufacturing processes relate to technologies that build 3-D objects by adding layer upon layer of material. The result is a stratified object which may feature unique, detailed structures, not producible by other technologies. The material may be plastic, metal, composite, the like, or a combination thereof. Additive manufacturing includes a number of technologies such as 3-D printing, rapid prototyping, direct manufacturing, layered manufacturing, additive fabrication, vat photopolymerization including stereolithography (SLA) and digital light processing (DLP), material jetting, binder jetting, material extrusion, powder bed fusion, sheet lamination, directed energy deposition, and the like.

Early additive manufacturing focused on pre-production visualization models, fabricating prototypes, and the like. The quality of the fabricated articles determines their use and vice versa. The early articles formed by additive manufacturing were generally not designed to withstand long-term use. The additive manufacturing equipment was also expensive, and the speed was a hindrance to a widespread use of additive manufacturing for high volume applications. But recently, additive manufacturing processes have become faster and less expensive. Additive manufacturing technologies have also improved regarding the quality of the fabricated articles.

Any additive manufacturing technique may be used to produce the disclosed integral cylinder head 102 with the valve guide 100 as additive manufacturing technologies operate according to a similar principle. The method may include utilizing a computer, 3-D modeling software (Computer Aided Design or CAD), a machine capable of applying material to create the layered intake manifold, and the layering material. An example method may also include creating a virtual design of the intake manifold in a CAD file using a 3-D modeling program or with the use of a 3-D scanner which makes a 3-D digital copy of the integral cylinder head, for example from an already created integral cylinder head. The method may include slicing the digital file, with each slice containing data so that the cylinder head 102 and the valve guide 100 may be formed layer by layer. The method may include reading of every slice by a machine applying the layering material. The method may include adding successive layers of the layering material in liquid, powder, or sheet format, and forming the integral cylinder head 102 and the valve guide 100 while joining each layer with the next layer so that there are hardly any visually discernable signs of the discreetly applied layers. The layers form the three-dimensional solid cylinder head 102, the valve guide 100 having the passage 110, the inlet 120, the outlet 122, the one or more annulus 123, the one or more ducts 124, the one or more groves 136 with seals 132.

As a result of the additive manufacturing, there may be no material seal between the above-described components of the integral cylinder head 102. This is due to forming of all the portions as integral portions of the cylinder head 102 instead of assembling individual components and sealing surfaces between the individual components, to form a uniform cylinder head.

The cylinder head 102, the valve guide 100 having the passage 110, the inlet 120, the outlet 122, the one or more annulus 123, the one or more ducts 124, the one or more groves 136 with seals 132, or a combination thereof may be made from the same or different material(s). For example, the material may be metal, plastic, ceramic, composite, or a combination thereof

The additively manufactured cylinder head 102 and the valve guide 100 may need to undergo one or more post-processing steps to yield the final 3-D object, for example stabilizing. Stabilizing relates to adjusting, modifying, enhancing, altering, securing, maintaining, preserving, balancing, or changing of one or more properties of the cylinder head formed by additive manufacturing such that the formed cylinder head meets predetermined standards post-manufacturing.

The stabilized cylinder head 102 and the valve guide 100, remains in compliance with various standards for several hours, days, weeks, months, years, and/or decades after manufacturing. The property to be altered may relate to physical, chemical, optical, and/or mechanical properties. The properties may include dimensional stability, functionality, durability, wear-resistance, fade-resistance, chemical-resistance, water-resistance, ultra-violet (UV)-resistance, thermal resistance, memory retention, desired gloss, color, mechanical properties such as toughness, strength, flexibility, extension, the like, or a combination thereof.

Additive manufacturing enables formation of intricate shapes, undulating shapes, smooth contours, gradual transitions between adjacent segments or parts of the cylinder head 102 and the valve guide 100, and fine portions such as the passage 110, the inlet 120, the outlet 120, the one or more ducts 124, and the like, resulting in an internal cooling system for the valve guide 100, utilizing a coolant which already circulates through the cylinder head 102. In addition to prolonging lifespan of the valve guide 100 and preventing the valve guide's 100 excessive wear, providing the coolant passage 110 in the valve guide 100 may have additional advantages. For example, the clearance of the valve stem to the valve guide 100 may be tightened, resulting in lesser oil consumption and release of lesser amount of emissions.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. An engine component comprising:
stratified layers forming an integral cylinder head, guide boss, and valve guide in the guide boss, the valve guide having walls defining an axial passageway configured to receive and guide a valve, and defining a coolant passage internal to the walls, wrapping around the axial passageway, and in fluid communication with a cylinder head cooling jacket via the guide boss.

2. The component of claim 1, wherein the guide boss defines a seal around the valve guide to an oil drain.

3. The component of claim 1, wherein the guide boss defines a seal around the valve guide to a combustion chamber.

4. The component of claim 1, wherein the guide boss defines a coolant inlet annulus and a coolant outlet annulus in fluid communication with the coolant passage and cylinder head cooling jacket.

5. The component of claim 1, wherein the coolant passage is helical.

6. The component of claim 1, wherein the coolant passage has a lattice structure.

7. The component of claim 1, wherein the coolant passage includes an inlet and an outlet in fluid communication with the cylinder head cooling jacket.

8. The component of claim 7, wherein the inlet is connected with a lower portion of the cooling jacket.

9. A powertrain assembly comprising:
layered material defining an integral cylinder head including
a valve guide having walls defining an axial passageway configured to receive and guide a valve, and defining an internal coolant channel having an inlet and outlet,
a cooling jacket,
a first duct between the cooling jacket and inlet, and
a second duct between the cooling jacket and outlet.

10. The powertrain assembly of claim 9, wherein the channel wraps around the axial passageway.

11. The powertrain assembly of claim 9, wherein the channel is helical.

12. The powertrain assembly of claim 9, wherein the channel includes a lattice structure.

13. The powertrain assembly of claim 9, wherein the inlet further includes a coolant inlet annulus and the outlet further includes a coolant outlet annulus.

14. The powertrain assembly of claim 9, wherein the cylinder head further includes an external seal to an oil drain arranged in a top portion of the valve guide.

15. The powertrain assembly of claim 9, wherein the cylinder head further includes an external seal to a combustion chamber arranged in a bottom portion of the valve guide.

16. An integral cylinder head comprising:
a guide boss; and
a fluid-cooled valve guide arranged in the guide boss and having a cylindrical body defining (i) an axial passageway configured to receive and guide a valve, (ii) a coolant passage internal to the cylindrical body, and (iii) an inlet and outlet in fluid communication with the coolant passage and a cooling jacket.

17. The integral cylinder head of claim 16, wherein the integral cylinder head, valve guide, and cooling jacket are formed from stratified layers such that there are no interfaces requiring separate seals between the cylinder head, valve guide, and cooling jacket.

18. The integral cylinder head of claim 16, wherein the integral cylinder head, valve guide, and cooling jacket are formed from the same material.

19. The integral cylinder head of claim 16, wherein the integral cylinder head defines a duct leading from the valve guide to the cooling jacket.

20. The integral cylinder head of claim 19, wherein the duct is bifurcated.
